(19) United States
(12) Patent Application Publication
(10) Pub. No.: US 2019/0172155 A1
(43) Pub. Date: Jun. 6, 2019

(54) SYSTEM AND METHOD FOR SCHEDULING DATA TRANSACTIONS

(71) Applicant: International Business Machines Corporation, Armonk, NY (US)

(72) Inventors: Donna K. Byron, Petersham, MA (US); Rama Kalyani T. Akkiraju, Cupertino, CA (US); John Black, Bristol (GB); Paul Lucas, Surrey (GB)

(21) Appl. No.: 15/832,401

(22) Filed: Dec. 5, 2017

(51) Int. Cl. G06Q 40/00

(52) U.S. Cl. CPC G06Q 40/125; G06Q 40/025

(57) ABSTRACT

Some embodiments include a method for scheduling data transactions in an electronic data transaction system. In some embodiments, the method can include presenting, by a filtering node, a user interface indicating options for rescheduling a data transaction to a later date; receiving, by the filtering node via the user interface, information indicating certain of the options that were user-selected; filtering, by the filtering node, the information to determine the user-selected options for rescheduling the data transaction to the later date; storing, in a transaction database, the user-selected options and the later date; identifying, by the filtering node on the later date, the data transaction in the transaction database; and processing, by the filtering node, the data transaction.

### BACKGROUND

Many electronic data processing systems receive electronic data over telecommunications networks and perform various processing on the electronic data. Some systems autonomously perform tasks based on pre-programmed schedules. For example, an accounting system may process data records associated with daily sales at midnight after every business day. As the number of records increases, the time needed for processing the records also increases. If results from processing particular data records are used by other electronic processes, a single delay may result in delay of many dependent processes. Certain data processing systems can take measures to avoid delays and more efficiently process electronic data.

### SUMMARY

Some embodiments include a method for scheduling data transactions in an electronic data transaction system. In some embodiments, the method can include presenting, by a filtering node, a user interface indicating options for rescheduling a data transaction to a later date. The method can further include receiving, by the filtering node via the user interface, information indicating certain of the options that were user-selected. The method can further include filtering, by the filtering node, the information to determine the user-selected options for rescheduling the data transaction to the later date. The method can further include storing, in a transaction database, the user-selected options and the later date. The method can further include identifying, by the filtering node on the later date, the data transaction in the transaction database. The method can further include processing, by the filtering node, the data transaction.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating a computer system capable of rescheduling data transactions, according to some embodiments.

FIG. 2 is a block diagram illustrating a filtering node according to some embodiments of the inventive subject matter.

FIG. 3 is a block diagram illustrating a user interface for scheduling data transactions according to some embodiments.

FIG. 4 is a flow diagram illustrating operations for rescheduling data transactions according to some embodiments.

FIG. 5 illustrates a data transaction record indicating a data transaction to be processed by a transaction processing system, according to some embodiments.

FIG. 6 is a flow diagram illustrating operations for processing data transactions according to some embodiments.

### DESCRIPTION OF EMBODIMENT(S)

The description that follows includes exemplary systems, methods, and techniques that embody the inventive subject matter. However, some embodiments may be practiced without these specific details. In some instances, well-known instruction instances, protocols, structures, and techniques have not been shown to avoid confusion and to provide a clear description of embodiments.

### Introduction

Distributed computer systems may include a plurality of geographically distributed computers connected via one or more telecommunications networks. These computers may include filtering nodes configured to process electronic data received over the telecommunications network(s). In some embodiments, filtering nodes can facilitate various remote services by filtering transactions and processing data associated with those transactions. In some instances, filtering nodes may be configured to provide services when certain conditions are met, such as at a given date/time, after a particular event has occurred, etc. For large-scale distributed systems that service a large number of users, network traffic and computing loads can become unmanageably high when the conditions for service are satisfied. For example, a company's filtering node(s) may process payroll for thousands of employees on a given day of the month. On payroll day, network traffic in-and-out of the filtering node(s) becomes very high, as does the node's computing load. Atypically high network traffic may cause costly delays for unrelated computer systems that utilize the same telecommunication network(s). Furthermore, the filtering node's high computing load may affect downstream processes that rely on payroll data, thereby creating a costly bottleneck. Embodiments of the inventive subject matter provide computerized components, logical rule sets, graphical user interfaces, and other components for alleviating network traffic and computational overload. Some embodiments enable users to reschedule tasks in unconventional ways. For example, companies conventionally determine when to pay employees—e.g., weekly, biweekly, monthly, etc. However, some embodiments provide electronic components that configure service parameters and schedule services (e.g., payroll services) based on user-selected options. Some embodiments utilize one or more filtering nodes to process user-selected parameters received via user interfaces, apply rule sets, and reschedule services to different times (e.g., according to application of the rule sets). Because embodiments enable unconventional rescheduling of tasks (e.g., employee-determined payroll dates), distributed computer systems can avoid costly network traffic spikes and computational bottlenecks.

### More Detailed Discussion of Some Embodiments

This section will provide more details about some embodiments of the inventive subject matter. The following discussion will describe components included in some embodiments. The following discussion will then describe operations and data structures utilized by some embodiments.

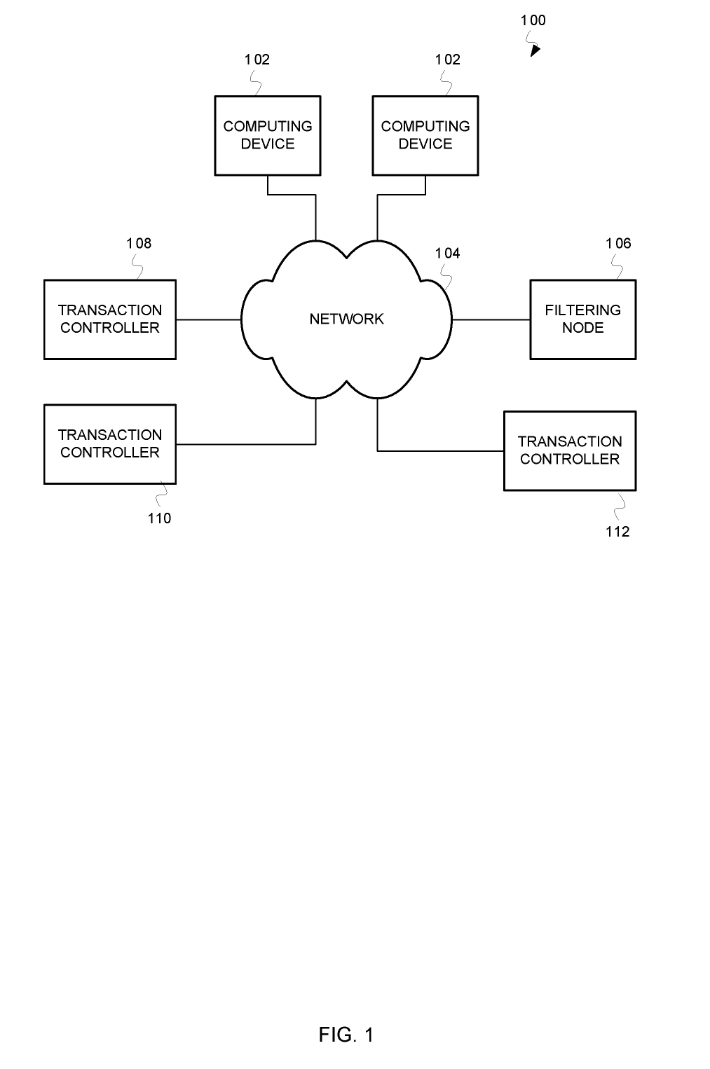

FIG. 1 is a block diagram illustrating a computer system capable of rescheduling data transactions, according to some embodiments. In FIG. 1, a data transaction system 100 includes computing devices 102, a telecommunications network 104, filtering node 106, and data transaction controllers 108, 110, and 112.

According to some embodiments, the computer system's filtering node 106 receives data transactions from one or more data transaction sources. For example, in a payment processing implementation, a company's payroll staff may electronically load data transactions relating to payroll into a transaction database residing on the filtering node 106. The company's employees can use the computing devices 102 to reschedule data transactions, such as rescheduling delivery of paycheck funds or other value earned by working for an employer. By rescheduling delivery of paycheck funds or other value, the data transaction system 100 can avoid spikes in computational load and network traffic. For example, although employee paycheck funds may be due on a particular date, some employees may reschedule delivery of their paycheck funds (or a portion of their paycheck funds) to a later date, thereby avoiding the need to process all employee paycheck funds on a given date. By distributing the transaction processing over a wider time frame, embodiments eliminate computational bottlenecks and relatively heavy network traffic that would occur if all data transactions were processed on the same date. In some instances, the system may encourage users (e.g., employees) to reschedule data transactions (e.g., paycheck fund delivery) to later dates by offering value in exchange for rescheduling. As a result, embodiments achieve computational and communication load-balancing by encouraging and enabling users to reschedule certain data transactions in unconventional ways—e.g., by enabling employees to delay delivery of all or part of their paychecks in exchange for interest accrued during the delay.

The devices shown in FIG. 1 can include one or more processors, memory, instructions for controlling operations, and other components for carrying out the functionality described herein. For example, the computing devices 102 can include mobile phones, tablet computers, laptop computers, or any other suitable computing devices.

The filtering node 106 can provide user interface content to the computing devices 102, and the filtering node 106 can filter requests to reschedule data operations (e.g., paycheck rescheduling requests) received via a user interface. The filtering node 106 can record the rescheduling requests, make offers to encourage users to reschedule data transactions, and carryout data transactions on the rescheduled dates. For example, the filtering node 106 can record paycheck rescheduling requests and associated transaction terms (e.g., interest rate, rescheduled payment date, etc.) in a transaction database. Upon the rescheduled date, the filtering node 106 can perform the data transactions. For example, on the rescheduled date, the filtering node 106 can facilitate an electronic funds transfer (delivery of paycheck funds) between transaction controllers 108 and 110. In some embodiments, the transaction controllers 108 and 110 operate as banking computers. That is, the transaction controller 108 may control one or more employee bank accounts, whereas the transaction controller 110 may control the employer's bank account. For embodiments in which the controllers 108 and 110 operate as banking computers, the controller 108 (employer banking computer) can receive information from the filtering node 106 and then transfer funds to the controller 110 (employee banking computer) on the rescheduled transaction date. Embodiments are not limited to rescheduling and processing payment transactions but can reschedule and process any suitable data transactions.

This discussion continues with a more detailed view of a filtering node.

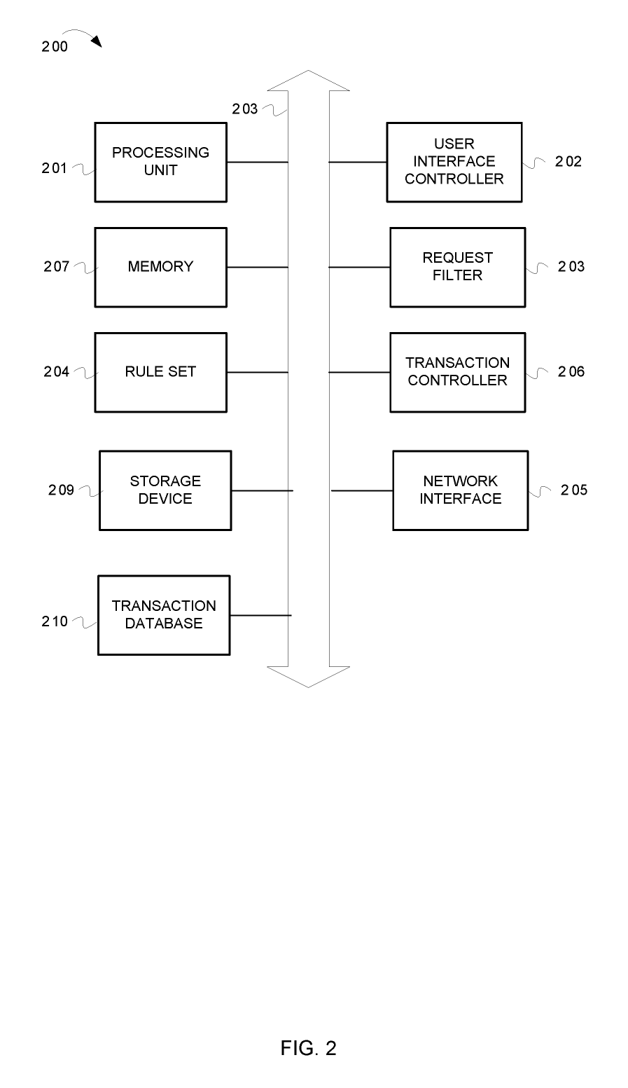

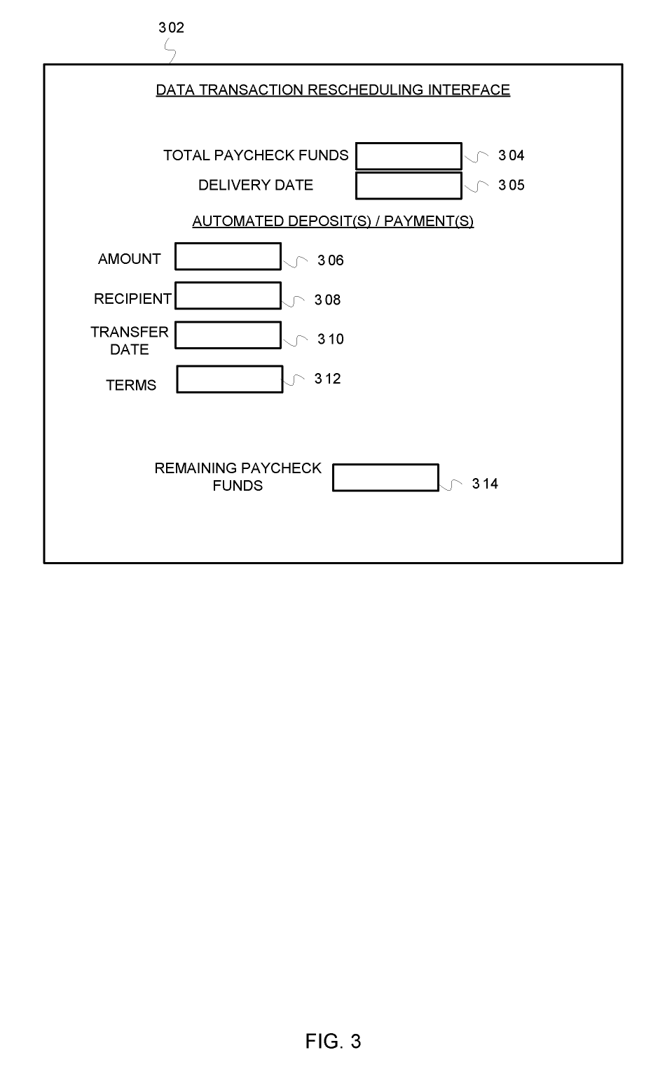

FIG. 2 is a block diagram illustrating a filtering node according to some embodiments of the inventive subject matter. In FIG. 2, the filtering node 200 includes a user interface controller 202, request filter 203, transaction controller 206, and rule set 204. The user interface controller 202 can provide content for providing, over a telecommunications network, a user interface on remote computing devices. The user interface can facilitate rescheduling of data transactions as described herein. An example user interfaces described in more detail below (see discussion of FIG. 3).

The request filter 203 receives, via the user interface, user-provided information about scheduling data transactions. For example, the request filter 203 may receive a request to reschedule delivery of paycheck funds to a later date. In some embodiments, the request filter 203 utilizes the rule sets 204 to determine offers that may encourage users to reschedule data transactions. For example, the request filter 203 may utilize the rule set 204 to determine an interest rate formulated to entice a particular number of employees to delay delivery of their paycheck funds until a later date. The rule set 204 may be updated to reflect how successful various offers have been. The rule set 204 may also include rules that increase or decrease interest rates or other rewards based on the system's need to reschedule data transactions. For example, in an implementation related to paycheck processing, the filtering node 200 can update the rule set to offer higher interest rates as an employer's need to retain cash is higher. Conversely, the rule set 204 may be configured to offer lower interest rates as the employer's cash needs are lower. The rule set 204 can be similarly updated for implementations unrelated to paycheck processing. In some embodiments, the rule set 204 may be represented in a series of labels, conditional statements, Boolean operators, and other logic for representing rule sets.

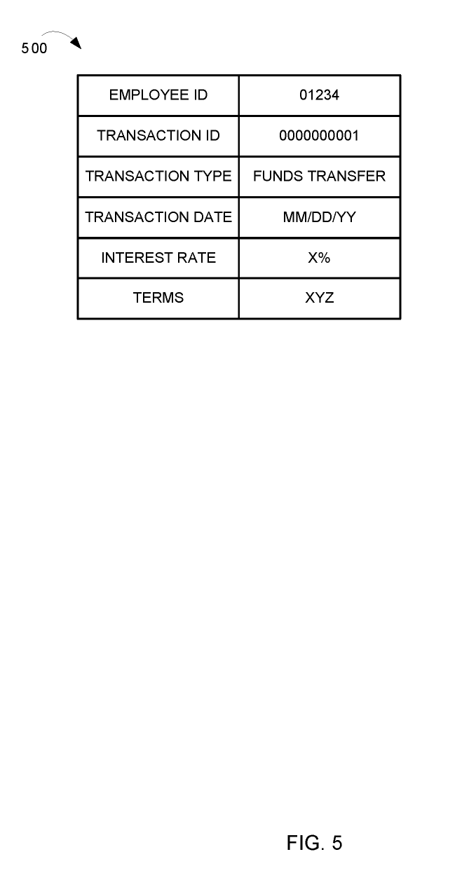

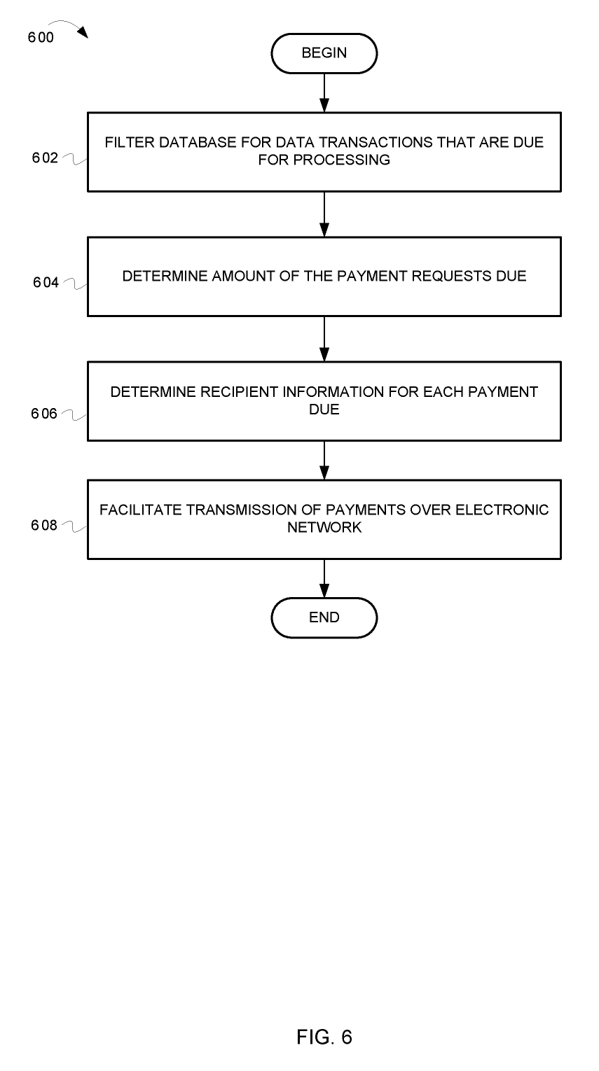

As data transactions are scheduled and rescheduled, the request filter 203 can update the transaction database 210. For example, payroll staff may schedule data transactions for delivering, on a given date, paycheck funds for certain employees. The request filter 203 can create records in the transaction database 210 for these data transactions. If an employee reschedules delivery of paycheck funds, the request filter 203 can update the transaction database 210 to reflect a new payment delivery date. The transaction database 210 includes information indicating data transactions to be processed by the transaction controller 206. In some embodiments, the transaction controller 206 periodically queries the transaction database 210 to identify data transactions that need to be processed (e.g., data transactions whose scheduling/rescheduling date has arrived). After inspecting the transaction database 210 for transactions that need processing, the transaction controller 206 can process those transactions. Operations for updating the transaction database 210, and processing data transactions are described in more detail in FIGS. 5 and 6.

The filtering node 200 also includes a processor unit 201 (possibly including multiple processors, multiple cores, multiple nodes, and/or implementing multi-threading, etc.). The filtering node 200 also includes memory 207. The memory 207 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 203 (e.g., PCI, ISA, PCI-Express, HyperTransport®, InfiniBand®, NuBus, etc.), a network interface 205 (e.g., an Ethernet interface, a WiFi, an LTE interface, etc.), and a storage device(s) 209 (e.g., optical storage, magnetic storage, etc.). Any the functionalities described herein may be partially (or entirely) implemented in hardware and/or on the processing unit 201. For example, the functionality may be implemented with an application specific integrated circuit, in logic implemented in the processing unit 201, in a co-processor on a peripheral device or card, etc. Further, realizations may include fewer or additional components not illustrated in FIG. 2 (e.g., video cards, audio cards, additional network interfaces, peripheral devices, etc.). The processor unit 201, the storage device(s) 209, and the network interface 205 are coupled to the bus 203. Although illustrated as being coupled to the bus 203, the memory 207 may be coupled to the processor unit 201.

This discussion will continue with a description of a user interface configured to enable users to reschedule data transactions.

FIG. 3 is a block diagram illustrating a user interface for scheduling data transactions according to some embodiments. In FIG. 3, a user interface 302 includes a plurality of data fields for presenting and receiving information. The user interface 302 is particularly adapted to scheduling payment transactions, but other embodiments may be adapted for scheduling other types of data transactions. As shown, the user interface 302 includes a total paycheck funds field 304 to indicate an amount of paycheck funds due, and a delivery date field 305 to indicate a date on which the paycheck funds will be delivered. Although not shown, embodiments may also indicate where the funds will be delivered, such as a bank account, bill payment, etc.

The user interface 302 includes data fields for scheduling data transactions. The amount field 306, recipient field 308, transfer date field 310, and terms field 312 facilitate data transaction scheduling. Some of these fields may be pre-filled with data selectable by user while others may receive data entered by user. A user can schedule/reschedule a data transaction by entering data or selecting options in the fields 306-312. For example, to reschedule delivery of payment funds, a user may select from predetermined fund amounts in the amount field 306, predetermined recipients (e.g., a bank account number) in the recipient field 308, and predetermined dates on which funds will be transferred (transfer date field 310).

Additionally, the user may accept terms, such as an interest rate or other conditions for rescheduling the data transaction. The terms appear in the terms field 312. In some embodiments, a filtering node utilizes a rule set to determine one or more of the terms as described above. If less than all paycheck funds have been rescheduled, the remaining fund amount as shown in the field 314.

As noted above, a user may be awarded value for rescheduling data transactions. In some instances, providing the value may give rise to creation of another data transaction to be performed at a later date. For example, the filtering node may create a new data transaction to pay interest for rescheduling delivery of paycheck funds. The new data transaction may be stored in the transaction database and processed when due.

This discussion will continue with operations performed by certain embodiments of the inventive subject matter.

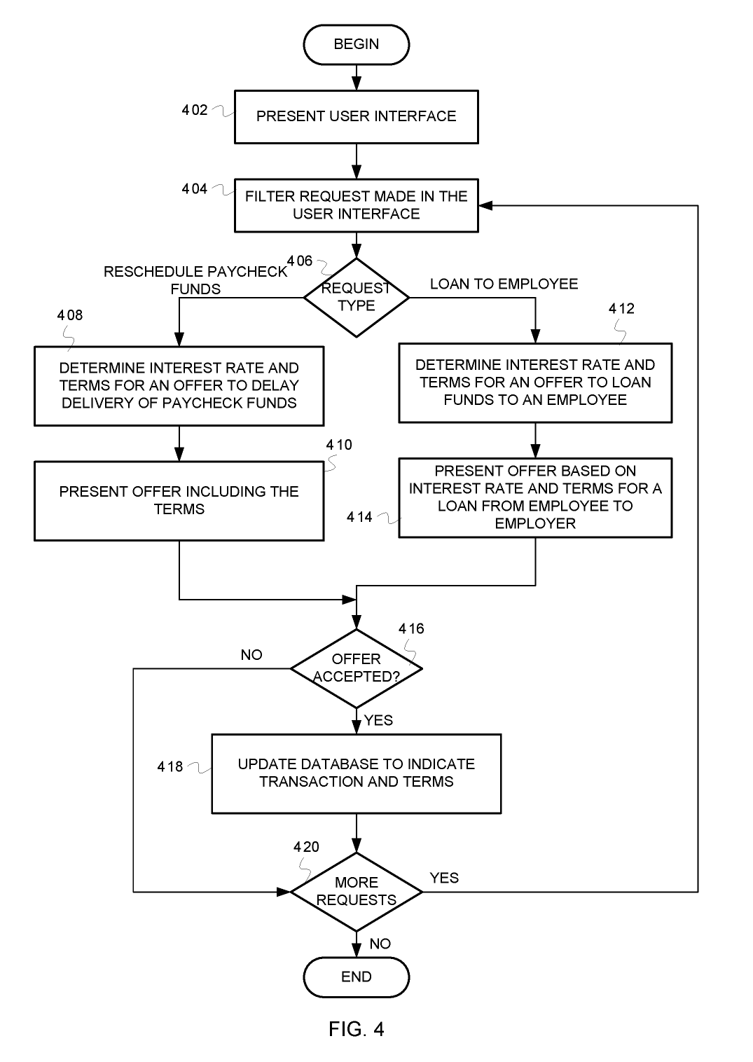

FIG. 4 is a flow diagram illustrating operations for scheduling data transactions according to some embodiments. The operations of FIG. 4 relate to scheduling data transactions relating to employee payroll and finance. However, other embodiments are not so limited, as they made relate to scheduling any suitable data transactions. In FIG. 4, a flow 400 begins at block 402.

At block 402, a filtering node's user interface controller 202 presents a user interface for scheduling data transactions. In some instances, the user interface enables the user to delay a data transaction. For example, the user interface may facilitate delaying delivery of paycheck funds. Alternatively, the user interface may facilitate scheduling of a data transaction. For example, the user interface may enable an employee to borrow from an employer, thereby scheduling a new payment transaction. In some embodiments, the user interface may be similar to that shown in FIG. 3. The flow continues at block 404.

At block 404, the filtering node's transaction filter 203 filters a transaction scheduling request made in the user interface. At block 406, the transaction filter 203 determines whether the request is for rescheduling delivery of paycheck funds or for scheduling delivery of funds for a loan to an employee. If the requested data transaction relates to rescheduling delivery of paycheck funds, the flow continues at block 408. Otherwise, the flow continues at block 412.

At block 408, for a request related to rescheduling paycheck funds, the filtering node's request filter 203 creates an offer for presentation to the user. The request filter 203 determines an interest rate and other terms for delaying delivery of paycheck funds. In some embodiments, the request filter 203 utilizes the rule sets 204 to determine the interest rate and other terms. The terms may include an interest rate earned for rescheduling delivery of the paycheck funds. In some embodiments, interest rates are offered based on parametric training, where rates are determined based on an employer's optimal cash flow, projected cash inflows, cost of capital, etc. In some embodiments, the request filter 203 estimates how much interest employees need at different times of the month and the historic response rate to particular offers. Over time, the transaction filter 203 can modify and optimize rules for setting interest rates, incentives, terms, etc.

At block 410, the request filter 203 presents, via user interface, the offer associated with rescheduling the data transaction. The flow continues at block 416.

At block 416 where the request filter determines whether the user accepted the offer. If the user accepted the offer (see block 418), the request filter 203 updates the transaction database 210 to indicate that the data transaction has been rescheduled and to record terms of the offer. In some instances, such as when interest will be paid for rescheduling the data transaction, the request filter 203 may add, to the transaction database 210, a transaction for paying interest to a user. In other embodiments, interest payments may be tracked in other suitable ways. The flow continues at block 420.

At block 420, if there are more data transaction scheduling requests, the flow loops back to block 404. Otherwise, the flow ends.

Referring back to block 406, if the transaction scheduling request relates to a loan to an employee, the flow continues at block 412. At block 412, the request filter 203 determines an interest rate and terms for an offer to loan funds to an employee. In some embodiments the request filter 203 uses a rule set 204 for determining terms of an offer to loan money to the employee. The rule set can be configured to make loan terms more favorable when the employer has an abundance of cash to loan. When cash is less abundant, the loan terms may be less favorable. Additionally, the rule set may change loan terms depending on the employee's credit worthiness. The flow continues at block 414.

At block 414, the request filter 203 presents, in the user interface, the offer including the terms that were determined at block 412. The flow continues at block 416 (see discussion above for description of blocks 416-420).

FIG. 5 illustrates a data transaction record indicating a data transaction to be processed by a transaction processing system, according to some embodiments. In FIG. 5, a data transaction record 500 includes fields for an employee identifier, transaction identifier, transaction type, transaction date, interest rate, and other transaction terms. However, in some embodiments, transaction records may include different fields. The data transaction record can be stored in a transaction database. In some embodiments, a transaction controller periodically inspects the transaction database for transaction records associated with transactions that are due for processing. In some instances, transactions are due for processing if the transaction date coincides with the current date. The terms field of the transaction record can include any suitable data indicating terms of the data transaction. As noted throughout this discussion, transaction records are not only related to employee payroll or financial transactions, but can be configured to accommodate any suitable data transactions.

FIG. 6 is a flow diagram illustrating operations for processing data transactions according to some embodiments. In FIG. 6, a flow diagram 600 begins at block 602.

At block 602, a filtering node's transaction controller 206 filters transaction records in the transaction database 210 to identify data transactions that are due for processing. In some embodiments, the data transactions relate to delivering funds to specified accounts/recipients. The flow continues at block 604.

At block 604, the transaction controller 206 determines a fund amount for the data transaction due for processing. At block 606, the transaction controller 206 determines recipient information for the data transaction. In some instances, the recipient may be identified as a bank account routing number or other electronic funds transfer identifiers. However, for embodiments unrelated to payment processing, blocks 604 and 606 may relate to operations for processing other types of data transactions. The flow continues at block 608.

At block 608, the transaction controller 206 facilitates electronic transfer of the payment due. In some instances, the transaction controller 206 transmits a wire transfer request to a remote transaction controller that manages an employer bank account from which funds are drawn. In turn, the remote transaction controller electronically transfers funds to the recipient (e.g., another transaction controller that manages an employee's bank account). From block 608, the flow ends.

In addition to the embodiments described above, some embodiments may include the following functionality.

In some embodiments, the data transaction system performs the following operations: 1. Receives capital requests (amounts plus date a payment must be made, and the interest rate that will be paid using traditional funding sources) from corporate or division finance staff, corresponding to payments owing to external parties. 2. Creates a combined schedule of outgoing payments to either external parties or employees/employee proxies. 3. Determines the interest rate offered for employee deferred payments or pay advances. Interest rates are offered based on parametric training, evaluated compared to optimal cash flow, projected cash inflows, assert minimal cost of capital, observe how much interest employees need at potentially different times of the month and the historic response rate of employees to the offer. After each cycle, the system evaluates interest setting strategy and adjust. 4. Analyzes pull requests from employees to determine if request falls within established parameters/thresholds for drawing loans against future earnings, withdrawing from the balance already earned, ensuring that transactions comply with any regulatory stipulations, etc. 5. Determine optimal time-scale of funds allocation to employee accounts (e.g. weekly or daily incremental account updates). Utilize tradeoff analytics to weigh additional cost of transactions against value such as employee retention due to innovative payroll arrangements, flattened liquidity demand, etc. 6. When employee payments are withdrawn, determine any adjustments to salary due—either interest owed to the employee (for deferred payment) or due from the employee (for advance pay). 7. Periodic assessment of liquid cash required and cost of funds from other sources, in order to post requests into the bid/ask system for employee micro-loans.

In some embodiment, the system can be configured in a variety of ways including: 1) push-oriented whereby a company offers delayed payment/compensation terms to employees, 2) pull-oriented as an employee benefit where employees may define their own schedule of payroll receipts and payees, 3) as a bid/ask system whereby a company posts requests for micro-loans from employees, employees bid with the interest rate they would want as compensation for delayed payments.

In some embodiments, the system may enable users to redirect paycheck funds to one or more recipients without rescheduling the date on which paycheck funds are to be delivered. For example, instead of a typical direct deposit into an employee's bank account, a filtering node can enable an employee to enter, via a user interface, a data transaction request that directs paycheck funds to pay the employees bills, fund designated accounts, etc. As a result, some do not directly deposit paycheck funds into employee bank accounts, but instead deliver funds directly to recipients designated by the employee.

Some embodiments of the request filter may determine that no interest is needed to incentivize offers to reschedule delivery of paycheck funds. Based on historic acceptance of offers and/or other information, the request filter may determine that offers will be accepted for convenience—e.g., to assist the employee in saving paycheck funds until the employee's bills are paid, to avoid expenses associated with employee bank accounts, etc.

When the transaction processing system is implemented to facilitate rescheduling delivery of paycheck funds and to facilitate employee loans, the system may provide one or more of the following benefits.
In some embodiments, as a benefit to employees, the system can help them better manage their household budget, such as by enabling them to retain funds at an interest rate within the company's bank account to be paid directly to the employees mortgage company on the day the mortgage is due. Paycheck funds rescheduling may be desirable in the case when payday is on the first of the month and the employee has a large payment (car, student load, mortgage) to be paid on the 20th. If the employee consistently has trouble letting enough funds stay in the employee's personal checking account to cover the payment, the employee may benefit by rescheduling delivery of paycheck funds, as described herein. Embodiments enable the employee to view the employee's accumulating pay as an account that can be drawn down in a flexible way, through more flexible timing or by making direct payments to external entities.
Some embodiments described herein facilitate consolidation of accounts as a benefit to employees, for example to leave payroll accumulating in a savings account dedicated to a particular purpose, such as a group of employees pooling funds to gain a group/bulk discount on purchase of goods (for example high tech goods such as computers and smart phones). To utilize these benefits, the employee can designate such accounts and related information in the user interface.
Some embodiments described herein can facilitate a revenue stream for the company, as some employees may wish to over-draw their accumulating payroll account at a stated interest rate. This would move some transactions currently taking place at high-cost venues such as payday loans into a benefits program the company itself could offer. The held payroll amounts can potentially be modeled as a micro investment portfolio owned by the employer.
Some embodiments described herein can facilitate a liquidity manager to the company, as payments owed to employees are broken into smaller/multiple disbursements in order to preferentially pay other amounts owed by the company. This could be proposed to employees with a particular interest-rate offered each pay period—e.g., employees receive their pay on the 5th this month for an interest return of 5%' (other months might be only 1% depending on the opportunity cost of the money to the company). Particular employees may see the benefit of delaying receiving some of their pay without having to be compensated with an offer of interest rate.
Some embodiments of the data transaction processing system operate as a bank or payroll processor offering services to employer commercial accounts. This could mean that the bank itself takes over some transactions currently being managed by the Human Resources or finance department within a company.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the inventive subject matter is not limited to them. In general, techniques for scheduling and rescheduling data transactions as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for scheduling data transactions in an electronic data transaction system, the method comprising:
presenting, by a filtering node, a user interface indicating options for rescheduling a data transaction to a later date;
receiving, by the filtering node via the user interface, information indicating certain of the options that were user-selected;
filtering, by the filtering node, the information to determine the user-selected options for rescheduling the data transaction to the later date;
storing, in a transaction database, the user-selected options and the later date;
identifying, by the filtering node on the later date, the data transaction in the transaction database; and
processing, by the filtering node, the data transaction.

2. The method of claim 1, wherein the data transaction is an electronic delivery of paycheck funds, and wherein the user-selected options include an interest rate paid for rescheduling the data transaction to the later date.

3. The method of claim 2, wherein the processing includes:
transmitting, over a telecommunications network to a first transaction controller, information for electronically transferring the paycheck funds from the first transaction controller to a second transaction controller.

4. The method of claim 3, where in the first transaction controller controls a first bank account associated with an employer paying the paycheck funds, and wherein the second transaction controller controls a second bank account associated with an employee receiving the paycheck funds.

5. The method of claim 1 further including:
determining the options for rescheduling the data transaction, wherein the determining includes
determining, based on a rule set, a value to incentivize user-selection of certain of the options.

6. The method of claim 5 further including:
updating the rule set to indicate the value associated with the user-selected options.

7. The method of claim 5 wherein the value increases based on data indicating a need for delaying the data transaction.

8. A machine readable storage medium including computer executable instructions that, when executed by one or more processors, perform operations for scheduling data transactions in an electronic data transaction system, the instructions comprising:
instructions to present, by a filtering node, a user interface indicating options for rescheduling a data transaction to a later date;
instructions to receive, by the filtering node via the user interface, information indicating certain of the options that were user-selected;
instructions to filter, by the filtering node, the information to determine the user-selected options for rescheduling the data transaction to the later date;
instructions to store, in a transaction database, the user-selected options and the later date;
instructions to identify, by the filtering node on the later date, the data transaction in the transaction database; and
instructions to process, by the filtering node, the data transaction.

9. The computer readable storage medium of claim 8, wherein the data transaction is an electronic delivery of paycheck funds, and wherein the user-selected options include an interest rate paid for rescheduling the data transaction to the later date.

10. The computer readable storage medium of claim 9, wherein the instructions to processing further include:
instructions to transmit, over a telecommunications network to a first transaction controller, information for electronically transferring the paycheck funds from the first transaction controller to a second transaction controller.

11. The computer readable storage medium of claim 10, where in the first transaction controller controls a first bank account associated with an employer paying the paycheck funds, and wherein the second transaction controller controls a second bank account associated with an employee receiving the paycheck funds.

12. The computer readable storage medium of claim 8, the instructions further including:
instructions to determine the options for rescheduling the data transaction, wherein the instructions determine the options include
instructions to determine, based on a rule set, a value to incentivize user-selection of certain of the options.

13. The computer readable storage medium of claim 12 further including:
instructions to update the rule set to indicate the value associated with the user-selected options.

14. The computer readable storage medium of claim 12 wherein the value increases based on data indicating a need for delaying the data transaction.

15. An electronic data transaction system comprising:
one or more processors;
a network interface configured to transmit data over at least on telecommunications network.
machine readable storage medium including a computer program product including computer executable instructions that, when executed by the one or more processors, perform operations for scheduling data transactions in the electronic data transaction system, the instructions comprising:
instructions to present, by the electronic data transaction system, a user interface indicating options for rescheduling a data transaction to a later date;
instructions to receive, by the electronic data transaction system via the user interface, information indicating certain of the options that were user-selected;
instructions to filter, by the electronic data transaction system, the information to determine the user-selected options for rescheduling the data transaction to the later date;
instructions to store, in a transaction database of the electronic data transaction system, the user-selected options and the later date;
instructions to identify, by the electronic data transaction system on the later date, the data transaction in the transaction database; and
instructions to process, by the electronic data transaction system, the data transaction.

16. The electronic data transaction system of claim 15, wherein the data transaction is an electronic delivery of paycheck funds, and wherein the user-selected options include an interest rate paid for rescheduling the data transaction to the later date.

17. The electronic data transaction system of claim 16, wherein the instructions to processing further include:
instructions to transmit, over a telecommunications network to a first transaction controller, information for electronically transferring the paycheck funds from the first transaction controller to a second transaction controller.

18. The electronic data transaction system of claim 17, where in the first transaction controller controls a first bank account associated with an employer paying the paycheck funds, and wherein the second transaction controller controls a second bank account associated with an employee receiving the paycheck funds.

19. The electronic data transaction system of claim 15, the instructions further including:
instructions to determine the options for rescheduling the data transaction, wherein the instructions determine the options include
instructions to determine, based on a rule set, a value to incentivize user-selection of certain of the options.

20. The electronic data transaction system of claim 19 further including:
instructions to update the rule set to indicate the value associated with the user-selected options.
